(19) United States
(12) Patent Application Publication
(10) Pub. No.: US 2018/0330647 A1
(43) Pub. Date: Nov. 15, 2018

(54) Display Button Mounting Device and Method

(71) Applicant: Robert Anthony Sipek, Lemont, IL (US)

(72) Inventor: Robert Anthony Sipek, Lemont, IL (US)

(21) Appl. No.: 15/974,422

(22) Filed: May 8, 2018

Related U.S. Application Data
(60) Provisional application No. 62/503,324, filed on May 9, 2017.
(60) Provisional application No. 62/544,562, filed on Aug. 11, 2017.
(60) Provisional application No. 62/544,302, filed on Aug. 11, 2017.

(51) Int. Cl. G09F 23/00; A44B 1/04; A63B 60/62

(52) U.S. Cl. CPC G09F 23/00; G09F 23/0066; A63B 2102/32; A63B 60/62; G09F 2023/0025; A44B 1/04

(57) ABSTRACT

A display button mounting devices for mounting a display button to an item is disclosed. The device comprises a button attachment area and a raised perimeter boundary. The button attachment area is configured to receive a display button. The button attachment area has an attachment device configured to removably join the button in the button attachment area. The raised perimeter boundary surrounds the button attachment area and is configured to secure the button against lateral displacing forces.

This application claims the benefit of U.S. Patent Application No. 62/503,324, filed May 9, 2017, and U.S. Patent Application No. 62/544,562, filed Aug. 11, 2017, and U.S. Patent Application No. 62/544,302, filed Aug. 11, 2017, each of the foregoing applications are herein incorporated by reference in their entirety.

### FIELD OF THE INVENTION

The invention relates to display button mounting devices and methods.

### BACKGROUND

Display buttons have been used in the United States by person desiring to indicate the support of a particular candidate, party, message, or cause. Such buttons are often worn on a person's lapel or shirt. Such buttons have not been limited to use for political purposes, but have been used for displaying content and messages of a variety of topics and purposes.

Display buttons sometimes comprise a mounting pin on the back side of the button for attaching to a lapel, for example. When the display button comprises a pin on the back side, it is sometimes referred to a pinback button. U.S. Pat. No. 564,356 shows exemplary early pinback buttons. U.S. Patent Application Publication No. 2017/0006976 discloses further examples of pinback buttons capable of displaying content on the front and having a pin for attachment on the back.

The present inventor recognized the need for a device for removably mounting a display button to an item, such as a golf club head cover or a bag. The present inventor recognized the need for a device that secures the display button against displacing forces that could dislodge the button from attachment to the item. The present inventor recognized the need for a device that would protect the edges of the display button from damage. The present inventor recognized the need for a device that provides a sleek and refined appearance of the button mounted to the item.

### SUMMARY

A display button mounting device for mounting a display button to an item is disclosed. The device comprises a button attachment area and a raised perimeter boundary. The button attachment area is configured to receive a display button. The button attachment area has an attachment device configured to removably join the button in the button attachment area. The raised perimeter boundary surrounds the button attachment area and is configured to secure the display button against lateral displacing forces.

In some embodiments, the attachment device has hooks or loops of a hook-and-loop fastener. In some embodiments, the hooks or look extend throughout the button attachment area. In some embodiments, the boundary is a piping.

In some embodiments, the boundary is a perimeter wall. The wall comprises rubber or plastic. The wall comprises an inside surface, a top surface, and an outside surface. The perimeter wall is joined to a floor. The wall is circular. In some embodiments, the wall comprises a deformable resilient rubber or plastic. The wall comprises an interior height of about ⅛ to about 3/16 of an inch.

In some embodiments, the display button mounting device is deployed on a bag. The bag comprises a shell and at least one interior compartment. The display button mounting device is deployed on a front side of the shell.

In some embodiments, the display button mounting device is deployed on a golf club head cover. The cover comprises a shell and at least one interior channel configured to receive a golf club head. The display button mounting device is deployed on a front side of the shell.

A method of securing a display button to an item is disclosed. A display button is removably attached to a button attachment area of the item with a hook and loop fastener, and a raised perimeter wall surrounds a perimeter of the display button when attached to the button attachment area.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a partially exploded front view of a golf club head cover comprising a first embodiment display button mounting device of the invention.

FIG. 1A is side view of the golf club head cover of FIG. 1.

FIG. 2 is a partially exploded front side of the golf club head cover of FIG. 1 comprising a second embodiment display button mounting device.

FIG. 3 is a rear view of a display button usable with the display button mounting devices of FIGS. 1 and 2.

FIG. 4 is a rear view of a second embodiment display button usable with the display button mounting devices of FIGS. 1 and 2.

FIG. 5 is a partially exploded front view of a bag comprising the display button mounting device of FIG. 2.

FIG. 6 is a side view of the bag of FIG. 5.

FIG. 7 is a perspective view of the display button mounting device of FIG. 2.

FIG. 8 is a partially exploded view of a second embodiment bag comprising the display button mounting device of FIG. 2.

### DETAILED DESCRIPTION OF THE EMBODIMENTS

The following description is presented to enable any person skilled in the art to make and use the invention. For the purposes of explanation, the specific nomenclature used provides a plural understanding of the present invention. While this invention is susceptible of embodiment in many different forms, the drawings and this description demonstrate specific embodiments of the invention with the understanding that the present disclosure is to be considered as an exemplification of the principles of the invention and is not intended to limit the invention to the specific embodiments illustrated.

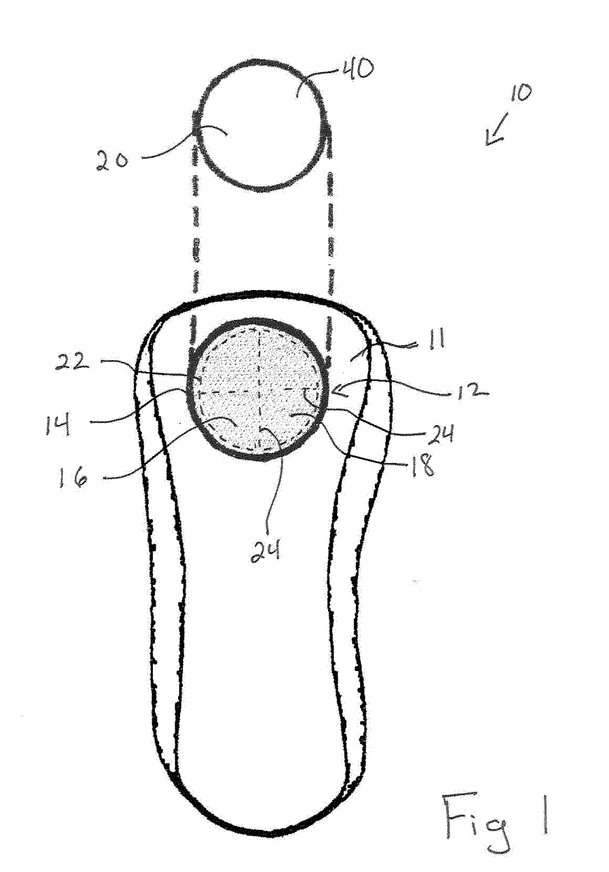

FIG. 1 shows a golf club head cover 10 having a display button mounting device 12 on a upper face 11 of the front 13 of the cover 10. The mounting device 12 comprises a perimeter boundary 14 and a button attachment area 16. The button attachment area 16 may comprise a means 18 of attaching a display button 20. In some embodiments, the golf club head cover is a golf club driver head cover.

In some embodiments, the means of attachment 18 comprises hooks or loops of a hook-and-loop fastener which are configured to mate with the other of the hooks or loops provided on a back 26 of the button 20. The hooks or loops in area 16 may be deployed on a fabric. The fabric and the hooks or loops may occupy the entire of the area 16 within the boundary 14. The fabric of the hook or loops can be attached to the cover 10 by stitching. In some embodiments, the stitching 22 extends about the periphery of the area 16 adjacent the boundary 14. In some embodiments, the stitching is embedded or within the boundary 14. In some embodiments, the stitching 22 comprises interior stitching 24, which may cross, as shown in FIG. 1.

In some embodiments, the perimeter boundary 14 is a piping. The piping is trimming stitched along the edges of the area 16. The piping is raised from the surface of the surrounding face 11. The raised piping can secure a button 20 fixed to the area 16 and protect the edge 42 of the button 20.

In some embodiments, the piping comprises leather or vinyl. In some embodiments, the leather is a bicast leather made with a split leather backing covered with a layer of polyurethane.

The button 20 will comprise an attachment means 28 on the back 26, such as the other of hooks or loops of a hook-and-loop-fastener. The hooks or loops may be deployed on a fabric. The fabric and the hooks or loops may occupy the entire of the area of the back of the button or a portion or less than the entire area. The fabric of the hook or loops can be attached to the back 26 by an adhesive, such as glue.

In some embodiments, the back of the button comprises a peripheral edge area 30 that is declined or recessed towards a central area 32 with a boundary crease 34 there between. The central area 32 may be flat or may be concave with a curvature that is less than the curvature or angle of the peripheral edge area 30.

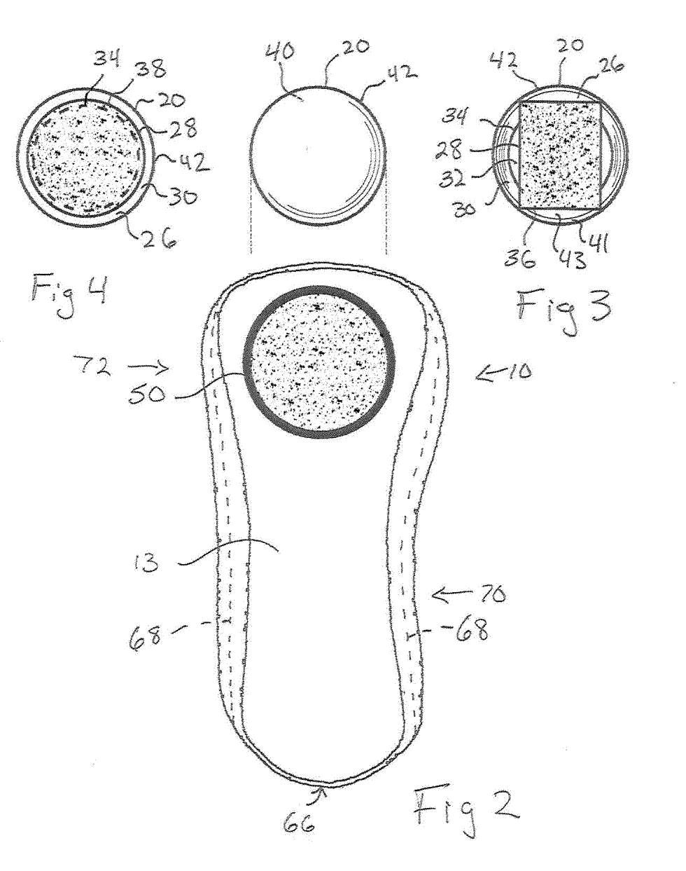

FIGS. 3 and 4 show two respective embodiments where the fabric having the hooks or loops comprises less than the entire back 26 of the button 20. In FIG. 3, the fabric 36 comprising the hooks or loops comprises a rectangular shape that partially covers the central area 32 and partially covers the peripheral edge area 30. In FIG. 4, the fabric 38 comprising the hooks or loops comprises a circular shape that completely covers the central area and partially covers the peripheral edge area 30 of the button. In one embodiment, the area 16 comprises the loops and the back of the button comprises the hooks.

A front 40 of the button is usually slightly convex, but may alternatively can be flat. Any content may be provided on the front of the button, such as a word(s), character(s), slogan(s), photo(s), logo(s), drawing(s), graphic(s), color(s), art, a combination thereof, or the like. In one exemplary application, the content on the front of the button might comprise a photo of a portion of a golf course with the name of the corresponding golf course provided over a portion of the photo. In another example, the content on the front of the button might comprise a company logo. In another example, the content on the front of the button might comprise a logo of a golf course, the name of the golf course, and the name of an event at the golf course, such as the “2018 Champion's Cup Open.” A transparent protective layer may be provided over the layer that comprises the content to protect the content from damage or deterioration by surface to surface contact or otherwise. In some embodiments the button comprises an at least two component design comprising a front plate that is curved over 41 a peripheral edge 42 and holds therein a back plate 43. In some embodiments, the back of the button is flat.

In some embodiments, the button 20 is a pinback button or badge where the pin on the back of the button has been replaced with the attachment means 28, such as hooks or loops of hook and loop fasteners.

The use of a releasable fastener to attach the button 20 to the device 12 and the cover allows the user to selectively change the style of the cover by changing the button attached to the cover at the user's liking.

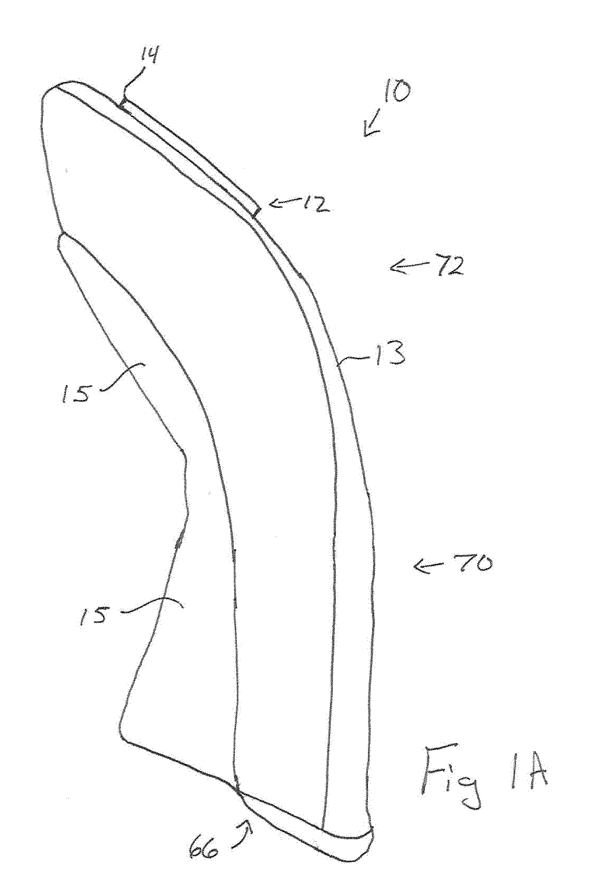

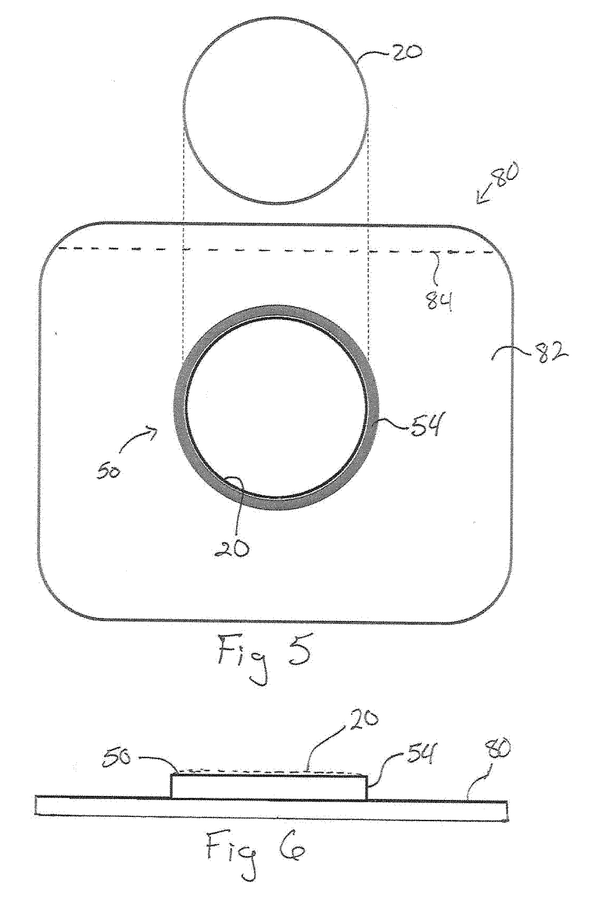

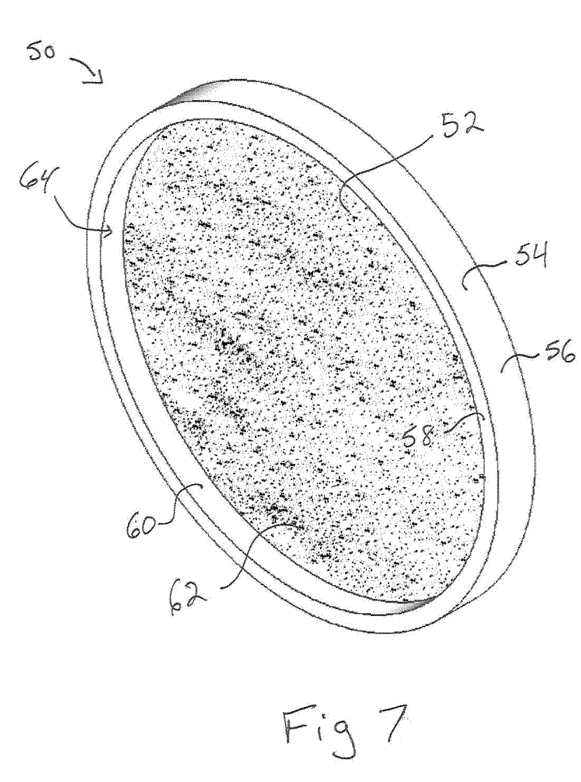

FIG. 2 shows an alternative embodiment mounting device 50 on the golf club head cover 10. The mounting device 50 is also shown in FIGS. 5, 6, 7 and 8. The device 50 comprises a bottom wall 52 and a perimeter wall 54. The bottom wall is joined to the perimeter wall 54 to form a semi-enclosed space 64 with an open top.

In some embodiments, the perimeter wall comprises an outside surface 56, a top surface 58, and an inside surface 60. The bottom wall comprises an attachment means, such as hooks or loops 62 of a hook and loop fastener. The hooks or loops may be mounted on a fabric. The fabric may be attached to the bottom wall 52 by stitching or adhesive or other attachment means. The fabric and therefore the hooks or loops may extend about the entire bottom wall so that the entire area within the perimeter wall comprises hooks or loops. In some embodiments, the fabric is attached with stitching such as stitching 22, 24 of FIG. 1.

In some embodiments, the perimeter wall 54 can comprise a height such that the front face 40 of the button does not extend above the top surface 58 of the perimeter wall. In some embodiments, such as shown in FIG. 6, the perimeter wall 54 comprises a height such that the front face 40 of the button 20 extends slightly above the top surface 58 of the perimeter wall. And the embodiments where the front face of the button 20 is convex the center of the button may comprise a height that is slightly higher than the perimeter edge of the button when located within the device 50. In some embodiments, the perimeter wall at the outside surface 56 comprises a height of about ¼ of an inch. In some embodiments, the height of the inside surface from the fabric to the top surface is about ⅛ to about 3/16 of an inch, inclusive. In some embodiments, the wall has a thickness of about ⅛ of an inch. In any case, the perimeter wall 54 can secure a button 20 fixed within the semi-enclosed space 64 and protect the edges of the button 20. Furthermore the perimeter wall can provide a pleasant finished appearance to the mounted button held therein.

The device 50 can be fixed to the cover 10 by the stitching extending from the fabric and bottom wall 52 through to the cover 10, such as stitching 22, 24, or by an adhesive, or by other attachment means.

The perimeter wall 54 secures the button 20 against displacing forces, such as laterally displacing forces that might arise when the edge 42 of the button is hit by a person or object. The perimeter wall protects the edge 42 of the button against damage. In some embodiments, the perimeter wall 54 may be composed of or comprise rubber or plastic, such as polyvinyl chloride. In some embodiments, the wall is flexible or deformable, but resilient to a standup orientation when not under a sufficient deforming load.

The cover 10 comprises a bottom opening 66 providing access to an interior channel 68. In some covers, a neck region 70 of the channel 68 is narrower than a head region 72 of the channel. A back side 15 opposite a front side 13 of the cover may comprise an elastic material. The channel on the back side 15 may also comprise the elastic material. The elastic material allows the neck region and the cover to flex open to accommodate a larger golf club head within the neck region until the head of the golf club is received in the head region 72 of the channel. When the head of the golf club is received in the head region of the channel the elastic nature of the elastic material draws the neck region back to its home state to secure the cover over the head of the golf club.

FIG. 5 shows the device 50 deployed on a bag 80. The device 50 is deployed on a front side 82 of the bag. The bag may comprise an opening 84 on a side of the bag opposite the front side 82. A zipper may be provided at the opening 84 for secured closing of the opening. The device 50 can be attached to the bag 80 in the same way that the device 50 is attached to the cover 10.

FIG. 5 shows that the peripheral edge 42 of the button 20 is very closely adjacent to the inside surface 60 of the wall 54 when the button 20 is within the device 50. In some embodiments, the edge 42 of the button is about one millimeter or less away from the inside surface 60. In some embodiments, the edge 42 of the button is in surface to surface contact with the inside surface 60 of the wall.

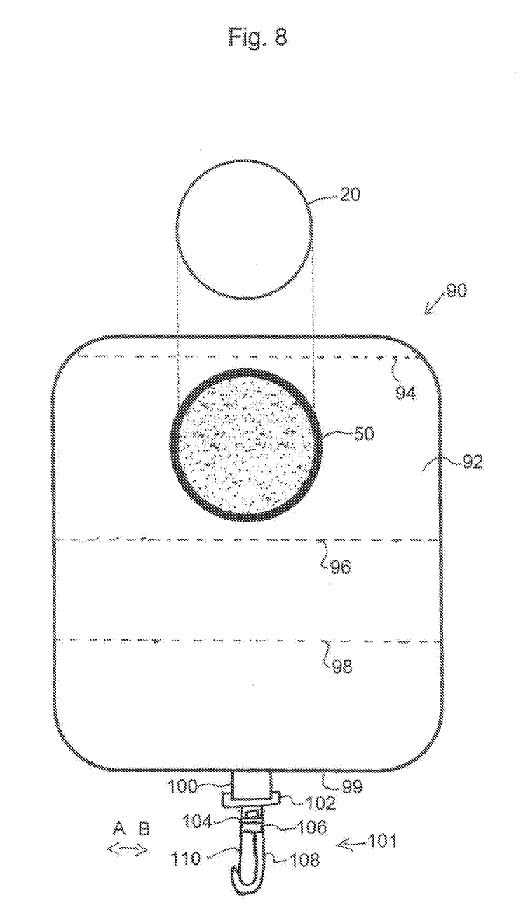

FIG. 8 shows a device 50 deployed on a second embodiment bag 90. The device 50 is deployed on a front side 92 of the bag. The bag may comprise a plurality of openings 94, 96, 98 providing access to one or more corresponding internal compartments of the bag. A zipper may be provided at each of the openings for secured closing of those openings. A hook 101 may extend from a side 99 of the bag. In some embodiments, a loop strap 100 extends from the bag and engages a loop base 102 of the hook 101. A second base 104 is fixed to the first base 102. A pivot base 106 is pivotally joined to the second base 104. A hook arm 108 extends from the pivot base 106. A closing arm 110 extends from the pivot base 106 spaced apart from the hook arm 108. The closing arm 110 is deformable in the direction B to open and biased in the direction A towards the terminal and of the hook arm 108 to form a closure.

In some embodiments, a carabiner (not shown) is used in place of the hook 101. The carabiner can be threaded through the loop strap 100. In some embodiments, the carabiner comprises a perimeter wall surrounding an open center. An openable gate member may interrupt the perimeter wall, and be pivotally attached to one end of the opening of the perimeter wall. The gate may pivot inward to provide access to the open center and may be biased to a closed position by a spring, where the gate closes the opening in the perimeter wall by connecting to each end of the opening. In some embodiments, any other hook or fastening device can be connected to the loop strap 100 for joining or releasably joining the bag to another object.

In some embodiments, the display button 20 and an interior diameter of the perimeter boundary 14, 54 each comprise at or about a three inch or at or about a 2.5 inch diameter. In some embodiment, the perimeter boundary 14, 54 is sized to correspond to the perimeter or diameter of the display button that is intended to be used therein. In some embodiments, the display button 20 and an interior diameter of the perimeter boundary 14, 54 each comprise a diameter in the range of 1 inch to 5 inches, inclusive. In some embodiments the buttons and corresponding perimeter boundaries 14, 54 comprises shapes other than a circle, such as oval, triangle, square, rectangle, or other shape.

In some embodiments, magnet(s) (not shown) are attached to the device 12, 50 and used in place of hook and loop fasteners for releasably connecting the button 20 to the device 12, 50. The magnets may be deployed only on the device 12, 50, or on the device 12, 50 and on the button. In some embodiment the back side of the button comprises a metallic material capable of being drawn by a magnet, such as metal.

While the devices 12, 50 have been shown on a golf club head cover and bags, the device is 12, 50 can be deployed on any item where it would be desirable to removably mount a button 20.

From the foregoing, it will be observed that numerous variations and modifications may be effected without departing from the spirit and scope of the invention. It is to be understood that no limitation with respect to the specific apparatus illustrated herein is intended or should be inferred. For example, one or more component or embodiments may be combined, modified, removed, or supplemented to form further embodiments within the scope of the invention. As a further example, steps provided could be carried out in a different order to achieve desired results. Further, steps could be added or removed from the processes described. Therefore, other embodiments and implementations are within the scope of the invention.

The invention claimed is:

1. A device for mounting a display button to an item, comprising:
a button attachment area configured to receive a button and comprising an attachment device configured to removably join the button in the button attachment area, the button attachment area is configured to be attached to the item; and,
a raised perimeter boundary surrounding the button attachment area and configured to secure the button against lateral displacing forces.

2. The device of claim 1, wherein the boundary is a piping.

3. The device of claim 1, wherein the attachment device comprises hooks or loops of a hook-and-loop-fastener.

4. The device of claim 3, wherein the hooks or loops extend throughout the button attachment area.

5. The device of claim 1, wherein the boundary comprises a 3 inch diameter.

6. The device of claim 1, wherein the boundary comprises a diameter in a range of 1 inch to 5 inches.

7. The device of claim 1, wherein the boundary is circular.

8. The device of claim 2, wherein
the attachment device comprises hooks or loops of a hook-and-loop-fastener, the hooks or loops extend throughout the button attachment area;
the boundary comprises a diameter in a range of 1 inch to 5 inches.

9. A golf club head cover, comprising
a shell comprising a front side and a back side;
an interior channel configured to receive a golf club head; and,
a display button mounting device on a front side of the shell, having
a button attachment area configured to receive a button and comprising an attachment device configured to removably join the button in the button attachment area, and,
a raised perimeter boundary surrounding the button attachment area and configured to secure the button against lateral displacing forces and to protect an edge of the button.

10. The cover of claim 9, wherein the boundary is a piping.

11. The cover of claim 9, wherein the attachment device comprises hooks or loops of a hook-and-loop-fastener; wherein the hooks or loops extend throughout the button attachment area.

12. The cover of claim 9, wherein the boundary comprises a diameter of about 3 inches or about 2.5 inches.

13. The cover of claim 10, wherein
the attachment device comprises hooks or loops of a hook-and-loop-fastener, the hooks or loops extend throughout the button attachment area;
the boundary comprises a diameter in a range of 1 inch to 5 inches.

14. A bag, comprising:
a shell comprising a front side and a back side;
at least one interior compartment; and,
a display button mounting device on a front side of the shell, having
a button attachment area configured to receive a button and comprising an attachment device configured to removably join the button in the button attachment area, and,
a raised perimeter boundary surrounding the button attachment area and configured to secure the button against lateral displacing forces and to protect an edge of the button.

15. The bag of claim 14, wherein the boundary is a piping.

16. The bag of claim 14, wherein the attachment device comprises hooks or loops of a hook-and-loop-fastener; wherein the hooks or loops extend throughout the button attachment area.

17. The bag of claim 14, wherein the boundary comprises a diameter in a range of 1 inch to 5 inches.

18. The bag of claim 15, wherein
the attachment device comprises hooks or loops of a hook-and-loop-fastener, the hooks or loops extend throughout the button attachment area;
the boundary comprises an about 3 inch or an about 2.5 inch diameter.
